(19) United States
(12) Patent Application Publication
(10) Pub. No.: US 2015/0170122 A1
(43) Pub. Date: Jun. 18, 2015

(54) ACCESSING CONTENT BASED ON PREVIOUSLY PURCHASED CONTENT

(71) Applicant: Samsung Electronics Co., Ltd., Gyeonggi-do (KR)

(72) Inventor: Kyung-Kuk SEO, Seoul (KR)

(21) Appl. No.: 14/565,557

(22) Filed: Dec. 10, 2014

(30) Foreign Application Priority Data
Dec. 16, 2013 (KR) 10-2013-0156358

(51) Int. Cl. G06Q 20/12

(52) U.S. Cl. CPC G06Q 20/127; G06Q 20/123

(57) ABSTRACT

A method and an apparatus for electronic payment is disclosed. New content is accessed by subtracting the access time of the new content from the remaining access time of previously purchased content.

### CLAIM OF PRIORITY

This application claims the benefit under 35 U.S.C. §119(a) of a Korean patent application filed in the Korean Intellectual Property Office on Dec. 16, 2013 and assigned Serial No. 10-2013-0156358, the entire disclosure of which is incorporated by reference herein.

### BACKGROUND

1. Technical Field

The present disclosure relates generally to a method for operating electronic payment and an electronic device thereof.

2. Description of the Related Art

Electronic devices, such as mobile phones, portable multimedia players (PMP), and personal digital assistants (PDA) are widely used and considered by many to be a necessity in today's society. Such devices may now provide a variety of different functions due to developments in communication technology. The advent of electronic communication technology has led to the development of electronic commerce that allows consumers to seamlessly purchase goods or multimedia content online. Users are capable of purchasing various content such as a photos, music, videos, e-books, etc. When paying for electronic content, various payment methods may be employed, such as pay per use, a flat rate, or a measured rate arrangement. For example, in a flat rate arrangement, a content provider may receive a flat rate in exchange for unlimited access to content for a limited time.

### SUMMARY

As noted above, users may pay a flat rate to obtain unlimited access to certain content on their device for a limited time. However, a user may later wish to have access to new content within the flat rate time window that was not initially paid for. In this instance, conventional systems may require a user to pay a new flat rate for the new content. Accordingly, a service that enables a user to purchase new content within the remaining flat rate time window is desirable.

In view of the foregoing, disclosed herein are an electronic device and method for transmitting electronic payments for content. In one aspect, a method may comprise: transmitting a request to a server for access to new content for a duration of time; identifying whether access to previous content has been purchased; identifying whether any prepaid access time remains for the previous content; subtracting the duration of time in which the new content is accessible from the prepaid access time, when access to the previous content was purchased and the prepaid access time remains; and accessing the new content for at least some of the duration of time.

In another aspect, an electronic device is provided. The electronic device may include: at least one processor to: transmit electronic payment to a server over a network in exchange for access to electronic content for a predefined access time; transmit a request to the server over the network for access to new electronic content different than the electronic content; identify whether any of the predefined access time remains; subtract a new access time associated with the new electronic content from the predefined access time that remains, when any of the predefined access time remains; and access the new electronic content over the network for at least some of the new access time.

In a further aspect, another method is provided. Such other method may include: transmitting electronic payment to a server over a network in exchange for access to electronic content for a predefined access time; transmitting a request to the server over the network for access to new electronic content different than the electronic content; identifying whether any of the predefined access time remains; identifying a new access time in which the new electronic content is accessible; subtracting the new access time from the predefined access time that remains, when the predefined access time remains and the predefined access time that remains is greater than the new access time; and accessing the new electronic content over the network for at least some of the new access time.

In yet another aspect, a further method may include: detecting, using at least one processor, receipt of a request for access to new content from a remote device; identifying, using at least one processor, whether electronic payment was received from the remote device for access to previous content; identifying, using at least one processor, whether any prepaid access time remains for the previous content; calculating, using at least one processor, a limited access time in which the new content is accessible, the limited access time being based on a return on investment; subtracting, using at least one processor, the limited access time from the prepaid access time, when access to the previous content was purchased, the prepaid access time remains, and the prepaid access time that remains is greater than the limited access time; and permitting, using at least one processor, the remote device to access the new content for the limited access time.

The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

The above and new content aspects, features and advantages of certain examples of the present disclosure will be more apparent from the following description taken in conjunction with the accompanying drawings in which:

FIG. 1 is a perspective view illustrating an example electronic device in accordance with aspects of the present disclosure;

FIG. 2 is a view illustrating an example system for purchasing electronic content in accordance with aspects of the present disclosure;

FIG. 3 is a block diagram illustrating an example electronic device in accordance with aspects of the present disclosure;

FIG. 4 is a flowchart illustrating an example method in accordance with aspects of the present disclosure;

FIG. 5 is a flowchart illustrating a further example method in accordance with aspects of the present disclosure;

FIG. 6 is a flowchart illustrating yet another example method in accordance with aspects of the present disclosure;

FIG. 7A, FIG. 7B, FIG. 7C, FIG. 7D, FIG. 7E and FIG. 7F are views illustrating example screen configurations for purchasing electronic content in accordance with aspects of the present disclosure;

FIG. 8 is a flowchart illustrating a further example method in accordance with aspects of the present disclosure; and

FIG. 9A, FIG. 9B, FIG. 9C, FIG. 9D and FIG. 9E are views illustrating example screen configurations in accordance with aspects of the present disclosure.

Throughout the drawings, like reference numerals will be understood to refer to like parts, components and structure.

### DETAILED DESCRIPTION

The following description is provided in conjunction with the accompanying drawings to assist with a comprehensive understanding of the techniques disclosed herein. Various details are described further below but it is understood that these are merely examples. Accordingly, it is understood that various changes and modifications may be made to the examples provided herein without departing from the scope and spirit of the disclosure.

In one example, an electronic device may include one or more of a smartphone, a tablet Personal Computer (PC), a mobile phone, a video phone, an electronic book reader, a desktop PC, a laptop PC, a netbook computer, a PDA, a PMP, an MP3 player, an ornament, an appcessory, a camera, a wearable device, a wrist watch, a refrigerator, an air conditioner, a cleaner, an artificial intelligence robot, a Television (TV), a Digital Versatile Disc (DVD) player, an audio, an oven, an electronic range, a washing machine, an electronic bracelet, an electronic necklace, an air purifier, an electronic frame, a medical device, a navigation device, a satellite signal receiver, an Event Data Recorder (EDR), a Flight Data Recorder (FDR), a settop box, a TV box, an electronic dictionary, an automobile infotainment device, electronic equipment for ship, an aviation electronic device, a security device, electronic clothes, an electronic key, a camcorder, a game console, a head-mounted display (HMD), a flat display device, an electronic album, a portion of a furniture or building/structure including an electronic device, an electronic board, an electronic sign input unit, and a projector. Also, it is obvious to a person of ordinary skill in the art that the electronic device according to the present disclosure is not limited to the above devices.

In the present disclosure, content may be defined as any tangible/intangible service in addition to electronic content that includes, but is not limited to, photos, videos, e-books, music, or text.

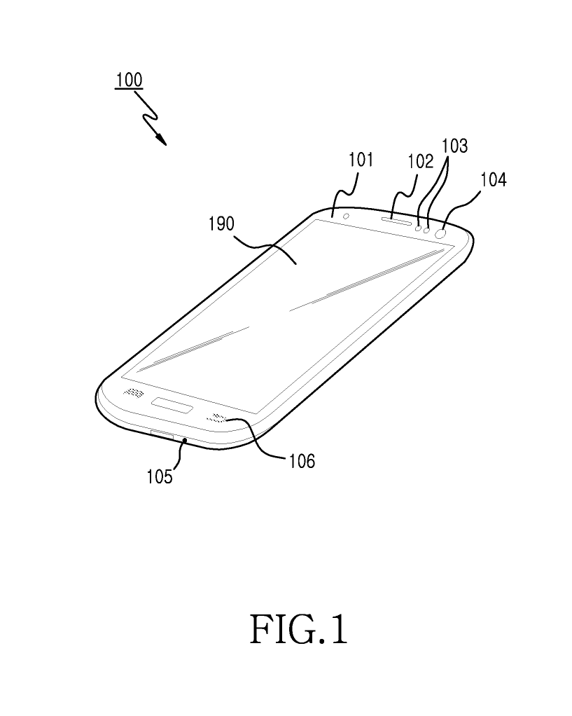

Referring now to the example of FIG. 1, a display unit 190 may be installed on a front surface 101 of electronic device 100. The display unit 190 may display an electric signal transferred from electronic device 100 in the form of text, graphics, videos, etc. Also, the display unit 190 may be implemented as a touchscreen that enables data input/output simultaneously using touch sensor technology.

A speaker unit 102 for receiving voice may be installed on the upper portion of the display unit 190, and a plurality of sensors 103 for use convenience of electronic device 100 such as a proximity sensor or an illuminance sensor, and a camera unit 104 for providing a camera function may be installed on the neighborhood of the speaker unit 102.

Electronic device 100 may further include a microphone unit 105 positioned on the lower side of the display unit 190, for receiving a sound, and a keypad unit 106 where key buttons are arranged. However, electronic device 100 is not limited thereto but various additional units for implementing new content known additional functions may be further installed to electronic device 100.

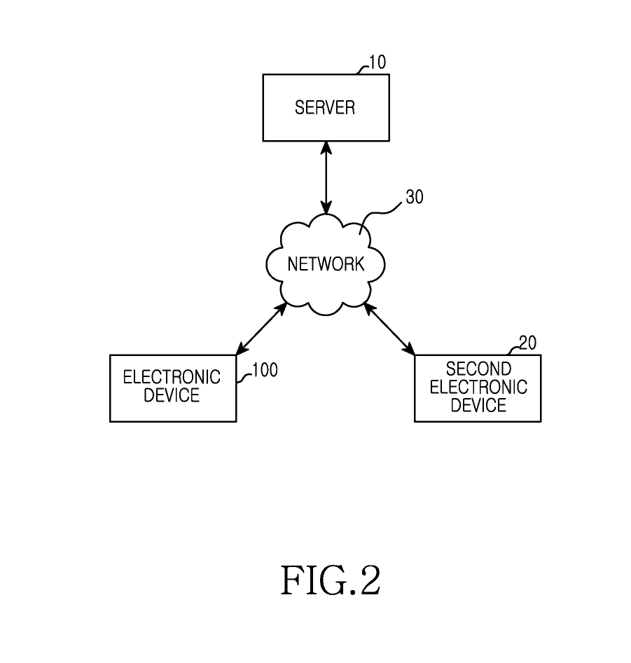

Referring to FIG. 2, an example system is shown. Electronic device 100 may communicate with a server 10 over network 30. Electronic device 100 may send electronic payments for and receive various multimedia content from the server 10. The electronic payment may be transmitted in accordance with a pay per use, a flat rate, or a measured rate system, but it is understood that the payment arrangement is not limited to the foregoing and that new content arrangements may be employed.

The server 10 may communicate with a plurality of electronic devices such as electronic device 100, a second electronic device 20, etc. to provide various multimedia content. Here, the server 10 may include, but is not limited to, a content provider that may provide various content, a content server, or a cloud server.

The server 10 may receive electronic payment in exchange for content from electronic device 100. For example, the server 10 may perform tasks that include, but are not limited to, user authentication, member registration, balance inquiry, billing log generation, and price settlement using an Internet Service Provider (ISP). The server 10 may further perform tasks associated with providing content.

In one example, when electronic device 100 sends an electronic payment to server 10 based on a flat rate, server 10 may provide a predefined access time or a limited access time in which a user of electronic device 100 may have unlimited access to the content. In conventional systems, a user of electronic device 100 may not be permitted to use any new content during that time; rather, conventional systems may require the user to make a separate flat rate payment for new content.

To solve this inconvenience, the electronic device 100 provided herein may purchase new content or new content different than the content that was originally or previously purchased by subtracting an access time in which the new content is accessible from the access time of the previously purchased content. The access time of the new content may be in accordance with the payment made for the previous content. By way of example, a user may purchase unlimited access to electronic content for a limited time (e.g., thirty days); then, the user may purchase new content for a different limited access time (e.g., 5 days) and the new limited time may be subtracted from the limited access time of the original content (e.g., 30 days minus 5 days). Accordingly, the remaining access time of the originally purchased content is reduced to 25 days.

In the example above, the content provider may consider a return on investment (ROI), when calculating the access time for the new content. In turn, a user may receive new content without a separate purchase procedure and the content provider may reduce the access time of the originally filed content while generating more revenue in the long term using the flat rate arrangement.

It is understood that other purchasing arrangements may be employed. These other purchasing systems include, but are not limited to, a time measured system, a packet measured system, a heat measured system, a session measured system, etc. depending on a characteristic for each service.

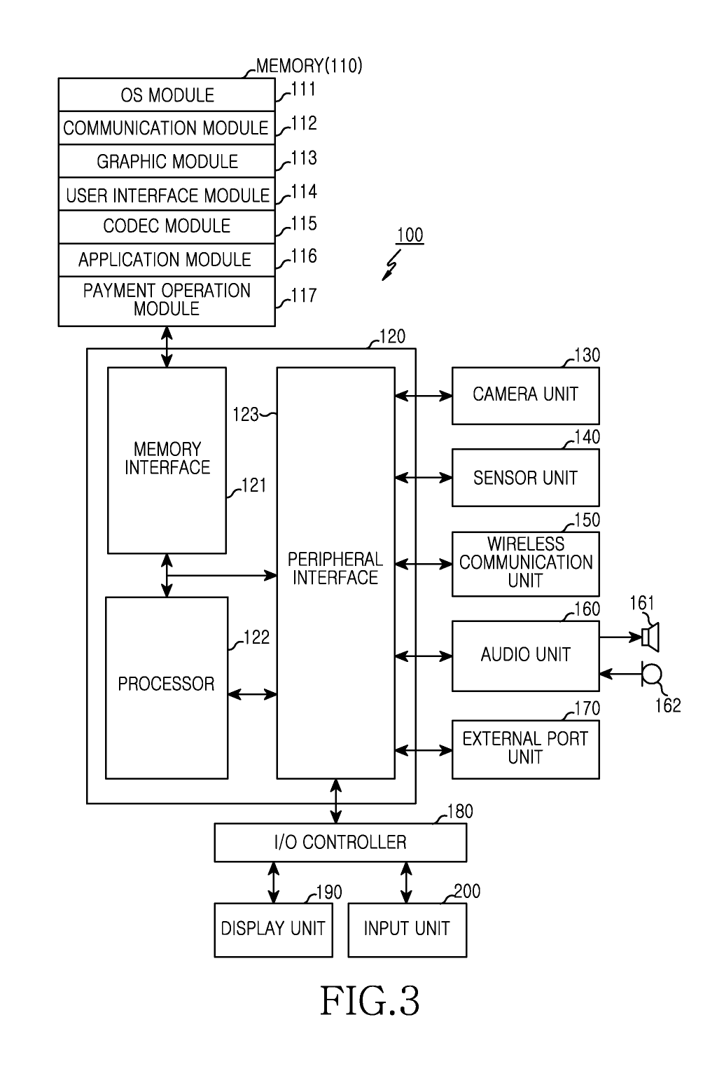

Referring to FIG. 3, a close up illustration of an example electronic device 100 is shown. Electronic device 100 may include a memory 110, a processor unit 120, a camera unit 130, a sensor unit 140, a wireless communication unit 150, an audio unit 160, an external port unit 170, an input/output (I/O) controller 180, a display unit 190, and an input unit 200. A plurality of memories 110 and external port units 170 may be provided.

Processor unit 120 may include a memory interface 121, at least one processor 122, and a peripheral interface 123. Here, the memory interface 121, the at least one processor 122, and the peripheral interface 123 included in processor unit 120 may be integrated in at least one integrated circuit or implemented as separate elements. The memory interface 121 may control an access of an element such as processor 122 or the peripheral interface 123 to the memory 110. The peripheral interface 123 may control connection between input/output peripheral of electronic device 100 and processor 122 and the memory interface 121.

Processor 122 may control electronic device 100 to provide various multimedia services using at least one software program. Processor 122 may execute at least one program stored in the memory 110 to provide a service corresponding to the relevant program.

Processor 122 may also execute various software programs to perform various functions for electronic device 100 and perform processes and controls for voice communication, video communication, and data communication. In addition, processor 122 may perform the examples of the present disclosure in cooperation with software modules stored in the memory 110. Processor 122 may further include one or more data processors, image processors, or a CODEC. Furthermore, electronic device 100 may configure the data processor, the image processor, or the CODEC, separately. Processor 122 may include one or more application processors (APs) and one or more communication processors (content providers).

In another content example, processor 122 may connect with the server 10 via a network, such as the Internet, to receive various multimedia content, and to transmit electronic payments in return for access to the content.

Various elements of electronic device 100 may be connected via one or more communication buses (referent numeral not shown) or electric connection means (referent numeral not shown).

The camera unit 130 may perform a camera function such as a photo, a video clip, recording, etc. The camera unit 130 may include a Charged Coupled Device (CCD) or a Complementary Metal-Oxide Semiconductor (CMOS), etc. In addition, the camera unit 130 may control change of hardware configuration, for example, lens movement, the number of apertures, etc. depending on a camera program executed by processor 122.

The camera unit 130 may provide a collected image obtained via shooting of an object to processor unit 120. The camera unit 130 may include an image sensor for converting an optical signal to an electric signal, an image signal processor for converting an analog image signal to a digital image signal, and a digital signal processor for performing video processing so that an image signal output from the image signal processor may be displayed on the display unit 190. Though not shown, the camera unit 130 may include an actuator for moving a lens, a driver integrated circuit (IC) for driving the actuator, etc.

The sensor unit 140 may include a proximity sensor, a Hall sensor, an illuminance sensor, a motion sensor, etc. For example, the proximity sensor may detect an object approaching electronic device 100, and the Hall sensor may detect magnetic force of a metal body. Also, the illuminance sensor may detect ambient light, and the motion sensor may include an acceleration sensor or a gyro sensor for detecting movement of electronic device 100. However, the sensor unit 140 is not limited thereto but may further include various sensors for implementing various known additional functions.

The wireless communication unit 150 enables wireless communication, and may include a radio frequency (RF) transmitter/receiver or a light (for example, an infrared) transmitter/receiver. Though not shown, the wireless communication unit 150 may include an RF IC unit and a baseband processor. The RF IC unit may transmit/receive a radio wave, and convert a baseband signal from the baseband processor to a radio wave, and transmit the same via an antenna. The RF IC unit may include an RF transceiver, an amplifier, a tuner, an oscillator, a digital signal processor, a CODEC chip set, a Subscriber Identify Module (SIM) card, etc.

The wireless communication unit 150 may be implemented to operate via at least one of a GSM network, an EDGE network, a CDMA network, a W-CDMA network, an LTE network, an OFDMA network, a Wi-Fi network, a WiMax network, an NFC network, an infrared communication network, a Bluetooth network depending on a communication network. However, the wireless communication unit 150 is not limited thereto but is applicable to various communication schemes that use a protocol for an e-mail, instant messaging, or a short message service (SMS).

The audio unit 160 may be connected to the speaker 161 and the microphone 162 to perform voice recognition, voice duplication, digital recording, or audio input/output function such as a communication function. The audio unit 160 may provide an audio interface between a user and electronic device 100, and convert a data signal received from processor 122 to an electric signal and output the converted electric signal via the speaker 161. The speaker 161 may convert an electric signal to an audible frequency band and output the same, and may be disposed on the front side or the backside of electronic device 100. The speaker 161 may include a flexible film speaker on which at least one piezoelectric body has been attached on one vibration film.

The microphone 162 may convert a sound wave transferred from a person or new content sound sources to an electric signal. The audio unit 160 may receive an electric signal from the microphone 162, convert the received electric signal to an audio data signal, and transmit the converted audio data signal to processor 122. The audio unit 160 may include an earphone detachable from the electronic device, an ear set, a headphone, or a head set, etc.

The external port unit 170 may directly connect electronic device 100 with a counterpart electronic device, or indirectly connect electronic device 100 with a counterpart electronic device via a network (for example, the Internet, an intranet, a wireless LAN, etc.). The external port unit 170 may include a USB port or a FIREWIRE port, etc.

The I/O controller 180 may provide an interface between an input/output unit such as the display unit 190 and the input unit 200, and the peripheral interface 123. The I/O controller 180 may include a display unit controller and new content input unit controller. However, the I/O controller 180 is not limited thereto but may receive various types of user inputs.

The display unit 190 may provide an input/output interface between electronic device 100 and a user. The display unit 190 may apply a touch detect technology to transfer the user's touch information to processor 122, and show visual information, text, graphic, or video, etc. provided from processor 122 to the user. The display unit 190 may display state information of electronic device 100, a character input by the user, a moving picture, and a still picture. In addition, the display unit 190 may display related information of an application driven by processor 122. The display unit 190 may include, but is not limited to, at least one of a Liquid Crystal Display (LCD), an Organic Light Emitting Diode (OLED), an Active Matrix Organic Light Emitting Diode (AMOLED), a Thin Film Transistor (TFT)-LCD, a flexible display, and a 3 dimensional display.

The input unit 200 may provide input data generated by the user's selection to processor 122 via the I/O controller 180. The input unit 200 may include a keypad including at least one hardware button and a touchpad for detecting touch information. The input unit 200 may include an up/down button for volume control. Besides, the input unit 200 may include at least one of a push button, a locker button, a locker switch, a thumb-wheel, a dial, a stick, a mouse, a track ball, or a pointer device such as a stylus, etc.

The memory 110 may include a high speed random access memory such as one or more magnetic disk storages or a non-volatile memory, one or more optical storages or a flash memory (for example, NAND, NOR). The memory 110 may store software that includes, but is not limited to, an Operating System (OS) module 111, a communication module 112, a graphic module 113, a user interface module 114, a CODEC module 115, an application module 116, and a payment operating module 117. In one example, a module may be defined as a set of instructions, an instruction set, or a program.

The OS module 111 may include, but is not limited to, WINDOWS, LINUX, Darwin, RTXC, UNIX, OS X, android, or a built-in OS such as VxWorks, and may include various software elements for controlling a general system operation. This control of the general system operation may include memory control and management, storage hardware (device) control and management, power control and management, etc. In addition, the OS module 111 may perform a function for swift communication between various hardwares (devices) and software elements (modules).

The communication module 112 may enable communication with a counterpart electronic device such as a computer, a server 10, and an electronic device, etc. via the wireless communication unit 150 or the external port unit 170.

The graphic module 113 may include various software elements for providing and displaying graphics to the display unit 190. A terminology of graphic may mean text, a web page, an icon, a digital image, a video, an animation, etc.

The user interface module 114 may include various software elements related to a user interface. The user interface module 114 may control to display related information of an application driven by processor 122 on the display unit 190. Also, the user interface module 114 may include content regarding how a state of the user interface changes or a condition under which the state of the user interface changes.

The CODEC module 115 may include a software element related to encoding and decoding of a video file.

The application module 116 may include a software element regarding at least one application installed to electronic device 100. This application may include, but is not limited to, a browser, an e-mail, a phonebook, a game, a short message service, a multimedia message service, a Social Network Service (SNS), an instant message, a morning call, an MP3 (MPEG Layer 3), schedule management, a paint board, a camera, word processing, keyboard emulation, a music player, a moving picture player, an address book, an e-book, a contact list, a widget, Digital Right Management (DRM), voice recognition, voice duplication, a position determining function, a position-based service, a money payment service, a user authentication service, etc. Here, a terminology of an application may be expressed as an application or an application software.

The payment operating module 117 may include various software elements for making electronic payments for content electronic device 100 attempts to access from the server 10. The payment operating module 117 may perform tasks that include, but are not limited to, user authentication, member registration, balance inquiry, billing log generation, and money payment. In addition, the payment operating module 117 may be configured to output a payment screen for payment on display unit 190.

Processor unit 120 may further include an additional module (instructions) besides the above modules.

Various functions of electronic device 100 may be executed by hardware or software including one or more application specific integrated circuits (ASICs). Though not shown, electronic device 100 may include a power system for supplying power to various elements included in electronic device 100. The power system may include, but is not limited to, a power source (alternating current (AC) power or battery), a power error detection circuit, a power converter, a power inverter, a charging unit or a power state display unit (a light emitting diode). In addition, electronic device 100 may include a power management and control unit for performing generation, management, and distribution functions of power.

Though the elements of the example electronic device 100 have been illustrated and described, it is understood that the electronic device shown herein is merely illustrative and that components may be added or deleted.

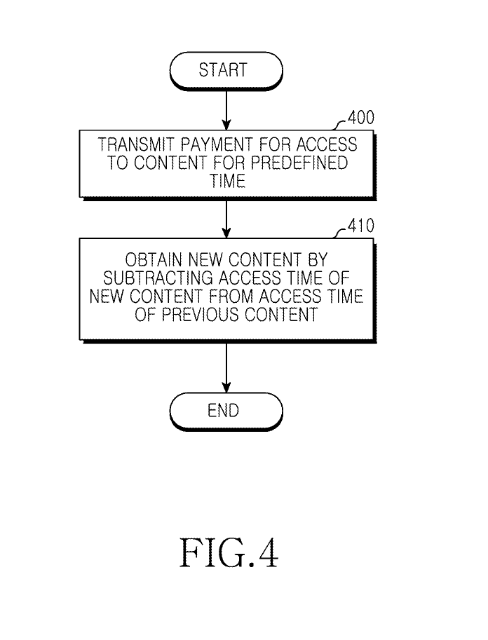

Referring to FIG. 4, an example method in accordance with aspects of the present disclosure is shown. Electronic device 100 may transmit electronic payment to a server in exchange for access to content for a predefined access time, in operation 400. As noted above, electronic device 100 may communicate with server 10 via network 30. Electronic device 100 may receive various multimedia content from the server 10, and transmit payment in return for access to such content for a limited time. As noted above, various purchasing arrangements may be employed including, but not limited to, pay per use, flat rate, and a measured rate arrangement.

When electronic device 100 transmits an electronic payment to server 10 based on a flat rate arrangement, the server 10 may calculate a limited access time that provides a user with unlimited access to the content during that time. In operation 410, electronic device 100 may obtain new content different than the previously purchased content by subtracting the limited access time associated with the new content from the limited access time associated with the originally purchased content.

By way of example, a user of electronic device 100 may purchase new content that was not originally purchased based on a flat rate by subtracting the limited access time calculated for the new content from the limited access time of the original content. By way of further example, when a user has unlimited access to electronic content for 30 days, the user may purchase new content simply by subtracting the calculated access time of the new content (e.g., 5 days) from the access time of the original content (e.g., 30 days). Accordingly, since the access time of the monthly fixed amount is subtracted by 5 days, the remaining access time of the previous content becomes 25 days.

In the example above, the content provider may consider a return on investment (ROI) for the new content to determine an access time for the new content. In turn, a user may receive new content without a separate purchase procedure and the content provider may reduce the access time of the original content while generating more revenue in the long term.

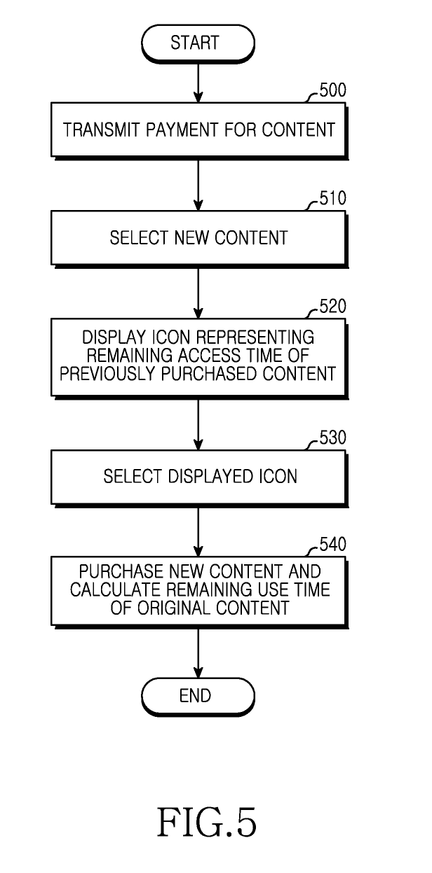

Referring now to FIG. 5, another example method is shown. Electronic device 100 may transmit an electronic payment in exchange for content in operation 500. As noted above, electronic device 100 may communicate with server 10 over network 30. Electronic device 100 may receive various multimedia content from server 10 in exchange for electronic payment.

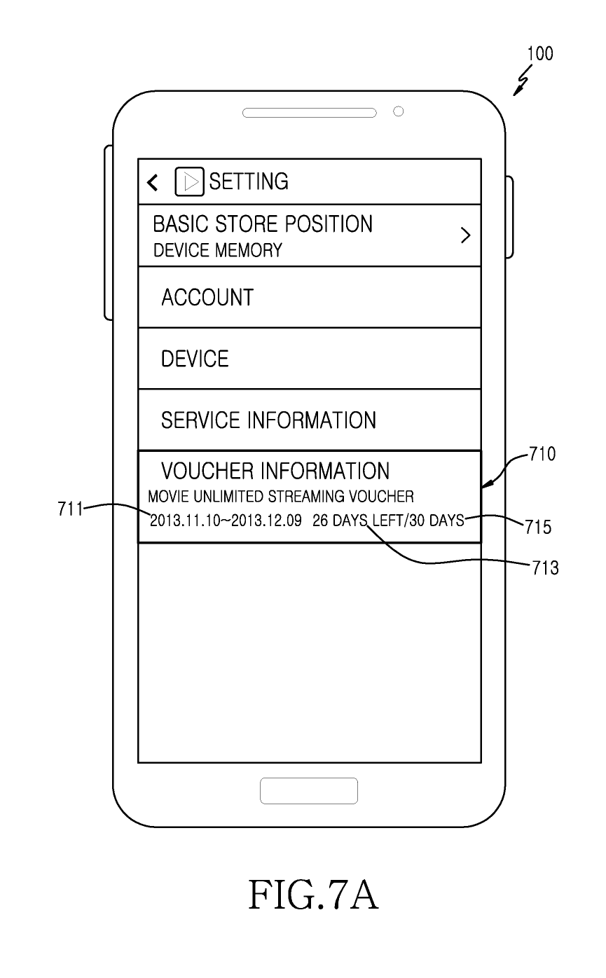

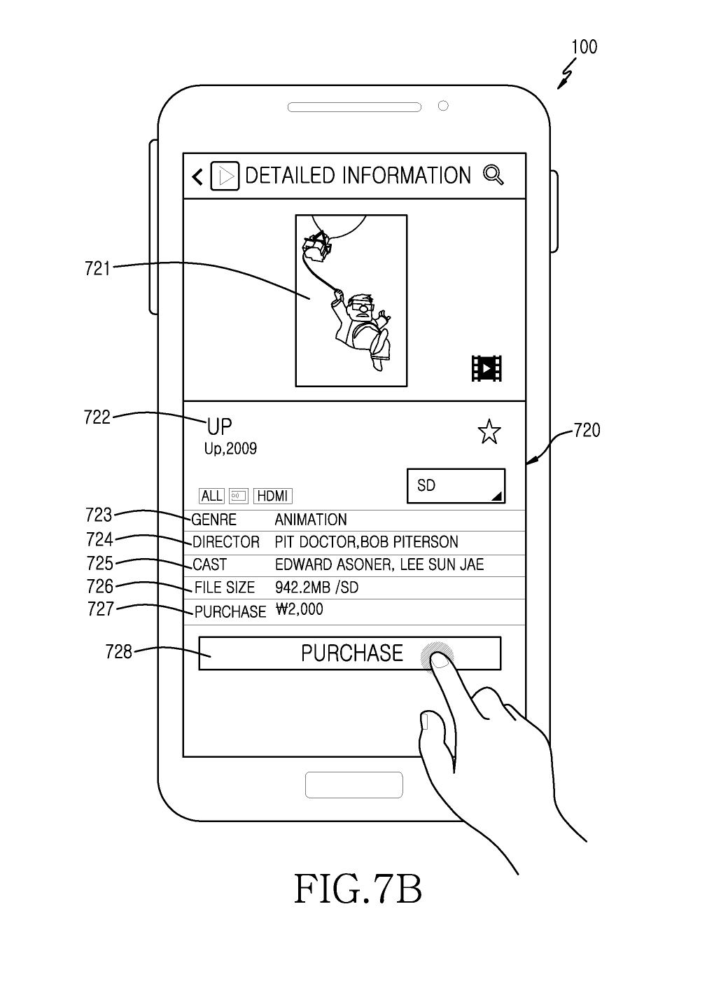

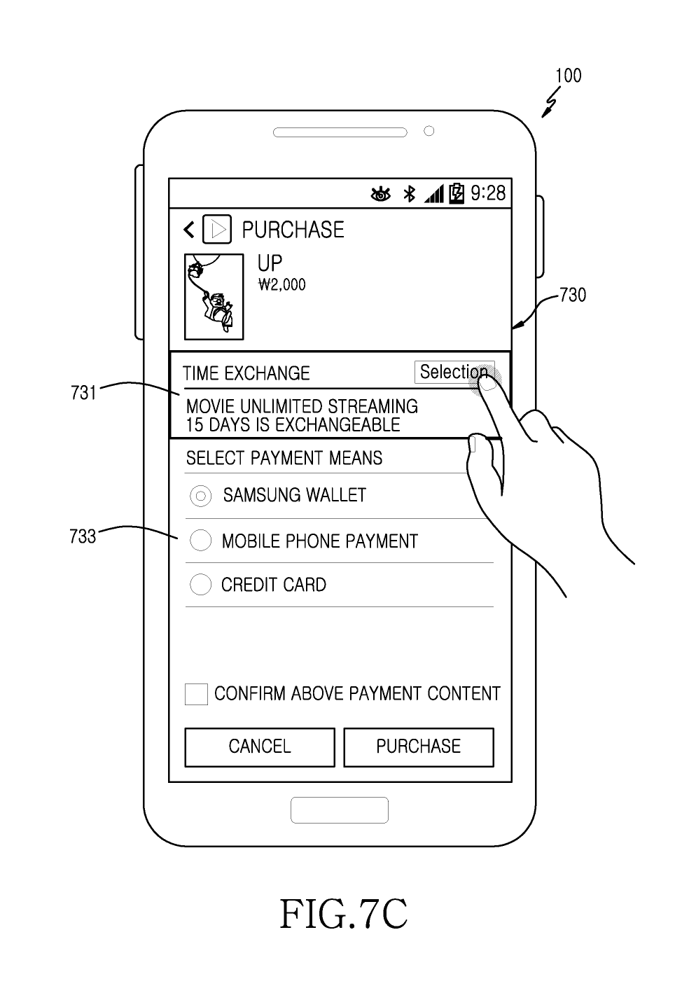

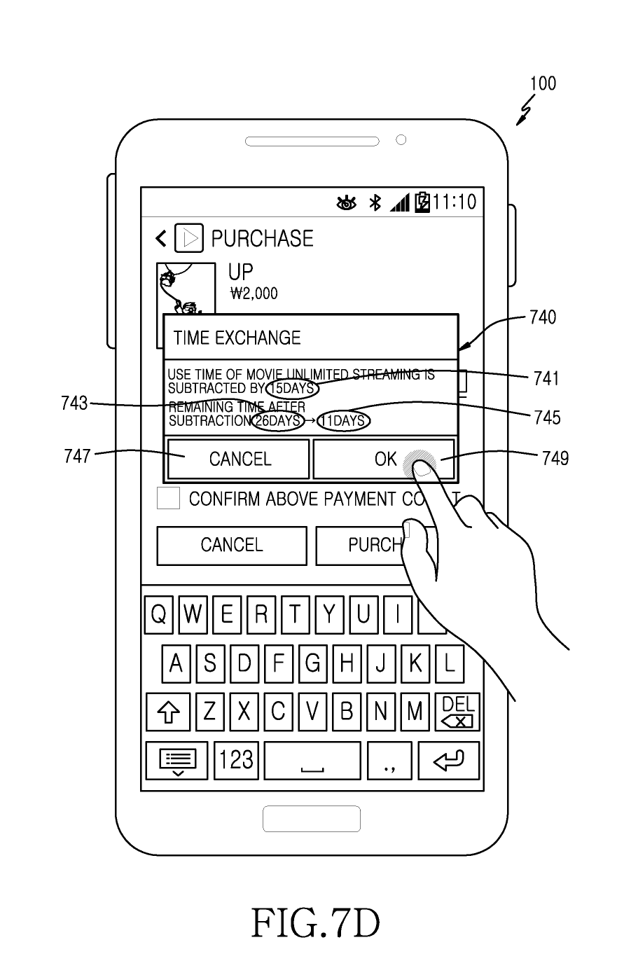

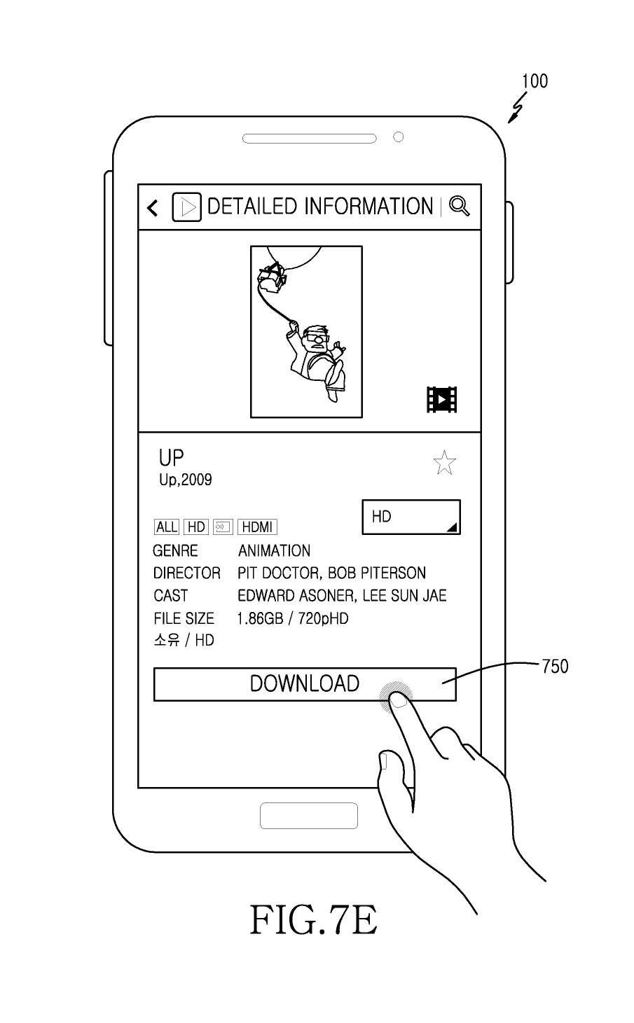

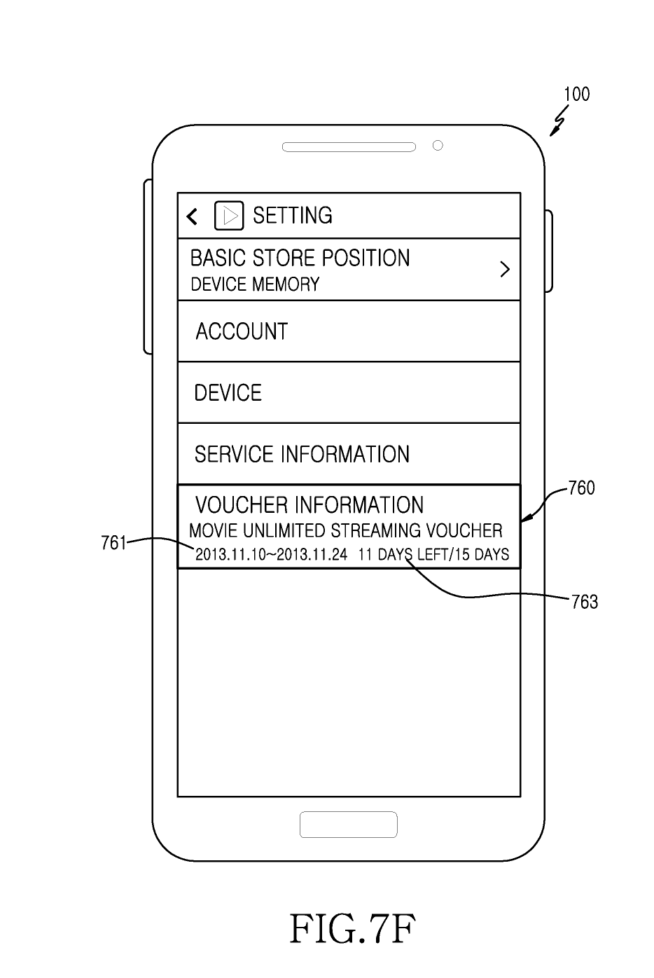

When electronic device 100 transmits electronic payment to the server 10 for content, the server 10 may provide a limited access time that provides unlimited access to the content during that limited time. By way of example, as illustrated in FIG. 7A, the user may view the access time 711, a remaining access time 713, and an entire access time 715 included in content information 710 displayed on the screen. However, it is understood that additional information may be displayed in the content information 710.

Referring back to FIG. 5, electronic device 100 may select new content that was not originally requested, in operation 510. In a further example, electronic device 100 may select the new content on a pay per use basis rather than the flat rate that was used for the original content.

As illustrated in the example of FIG. 7B, electronic device 100 may display a detailed information window regarding the new content. FIG. 7B depicts a detailed information window 720 that may include, but is not limited to, image 721, a title 722, genre information 723, director information 724, cast information 725, a file size 726, and a purchase price 727. Furthermore, electronic device 100 may display a purchase button 728 positioned at the lower end of the detailed information window 720 that enables a user to purchase the new content.

In one example, when the purchase button 728 is selected, electronic device 100 may display a payment select window 730 for content payment as illustrated in FIG. 7C. The payment select window 730 may include, but is not limited to, an object 731 for purchasing content and an object 733 for general payment of the content on the lower portion of the object 731. Electronic device 100 may display an icon representing a remaining access time of the originally or previously purchased content after subtracting the access time corresponding to the newly purchased content, in operation 520.

Referring now to the example of FIG. 7D, when object 731 is selected, electronic device 100 may output a term exchange determination window 740. The term exchange determination window 740 may include, but is not limited to, a subtracted use time 741 that will be subtracted from the original access time; the original access time 743 of the original content; and, a remaining access time 745 that reflects the cost of the new content after subtraction. The term exchange determination window 740 may further include buttons 747 and 749 for confirming or cancelling a term exchange.

Referring back to FIG. 5, electronic device 100 may select the displayed icon in operation 530. Referring back to FIG. 7D, electronic device 100 may detect a selection of an OK button 749 of the term exchange determination window 740 to purchase the new content. Referring back again to FIG. 5, electronic device 100 may purchase the new content and calculate a remaining access time for the original content in operation 540. As noted above, the remaining access time may be calculated by subtracting the new access time of the new content from the original access time of the original content.

Referring now to the example of FIG. 7E, electronic device 100 may detect selection of a download button 750 that triggers a download of the new content. Referring now to the example in FIG. 7F, a user may determine a subtracted access time 761 and the remaining access time 763 for the new content via the content information 760 displayed on the screen.

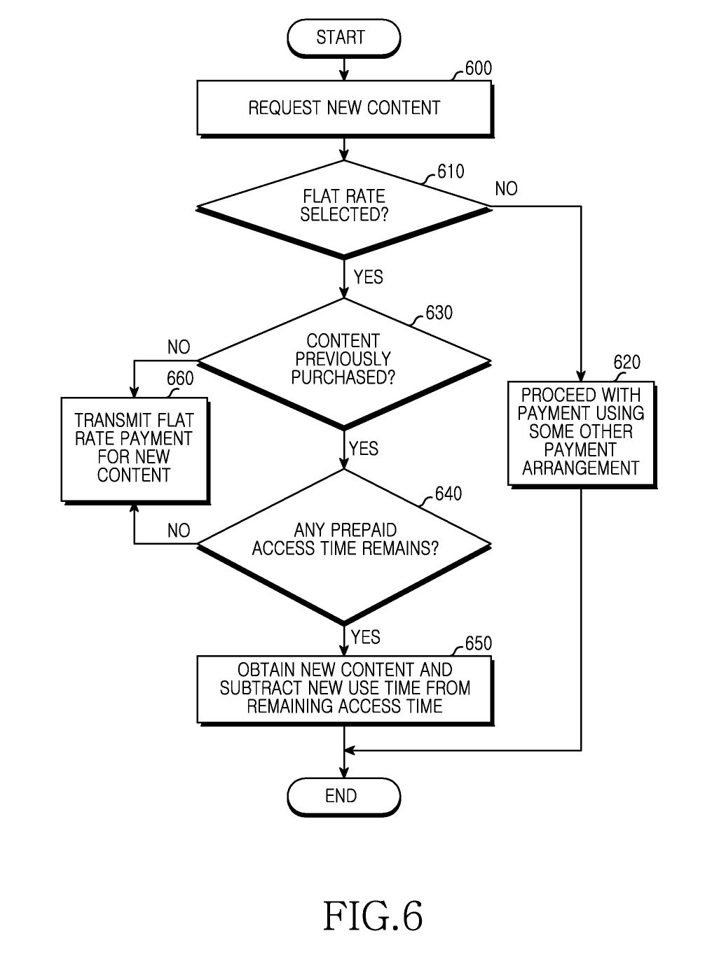

Referring now to FIG. 6 a further example method is shown. Electronic device 100 may request new content from the server different than the content that was originally purchased in operation 600. In one example, the new content may be purchased based on a payment arrangement different than a flat rate. The new content may include, but is not limited to, a photo, a video, sounds, an e-book, or text provided from the server 10.

Electronic device 100 may display payment information associated with the new content. Electronic device 100 may determine whether a user selects to purchase the new content for a flat rate in operation 610. When a flat rate is not selected, electronic device 100 may transmit an electronic payment for purchasing the new content using some other payment arrangement in operation 620. When the flat rate is selected, electronic device 100 may identify whether a content was previously purchased, in operation 630. Electronic device 100 may display the remaining access time of the original content, the new access time of the new content, and a remaining access time of the original content after the new access time is subtracted therefrom.

If no content was previously purchased, electronic device 100 may transmit an additional flat rate electronic payment in exchange for access to the new content for a limited access time in operation 660.

If content was previously purchased, electronic device 100 may determine whether any prepaid access time for the originally purchased content remains in operation 640. If no access time for the originally purchased content remains, electronic device 100 may transmit a flat rate electronic payment for unlimited access to the new content for a limited time in operation 660. In a further example, electronic device may also verify that the prepaid access time is greater than the new access time for the new content. If some access time for the original content does remain, electronic device 100 may obtain the content and subtracts the access time of the new content from the access time of the original content, in operation 650.

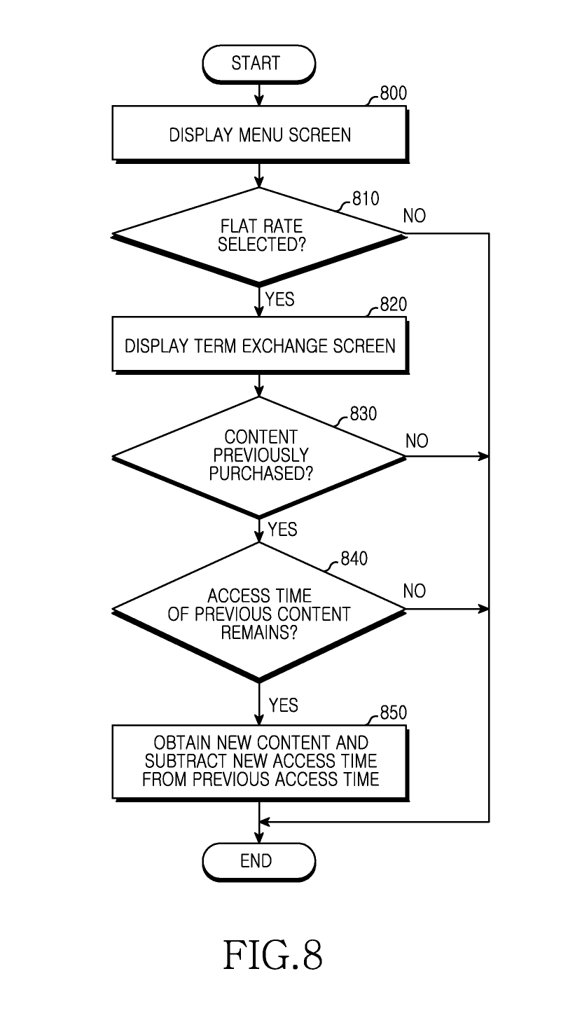

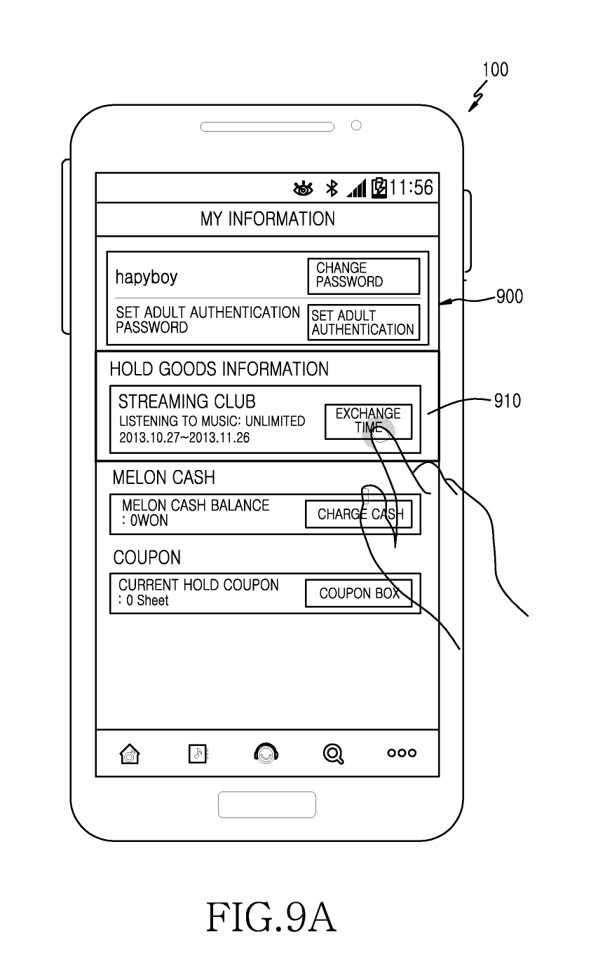

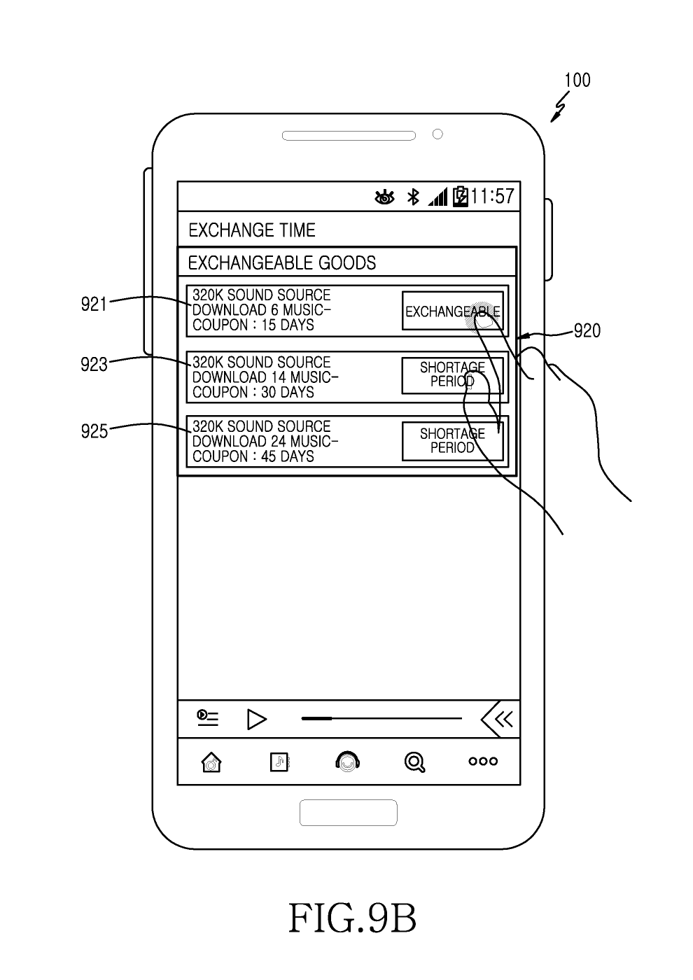

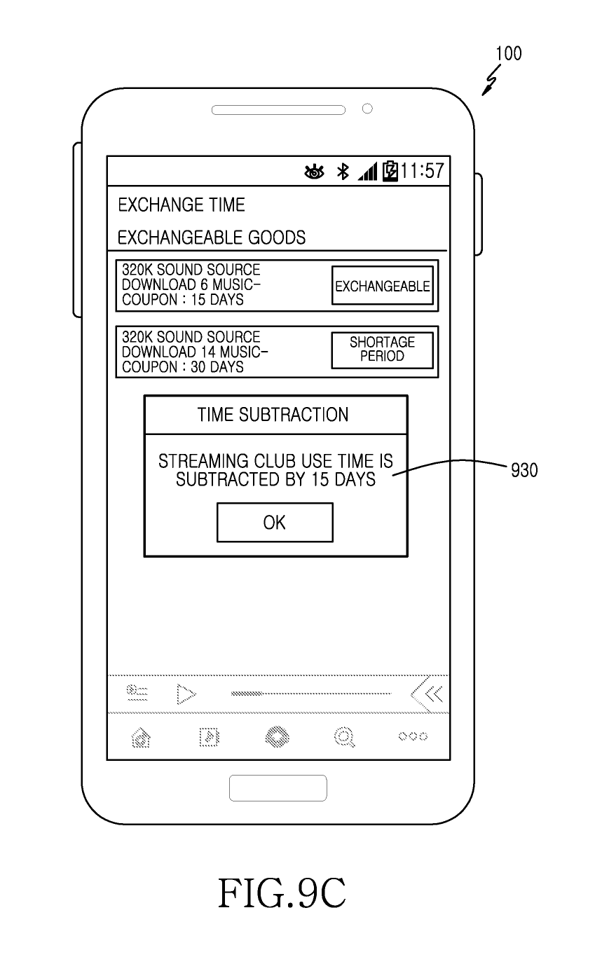

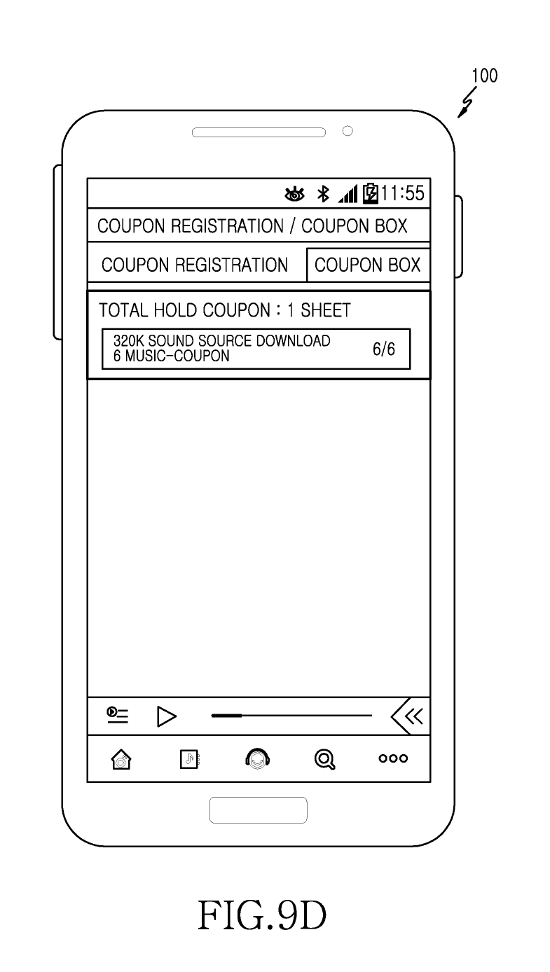

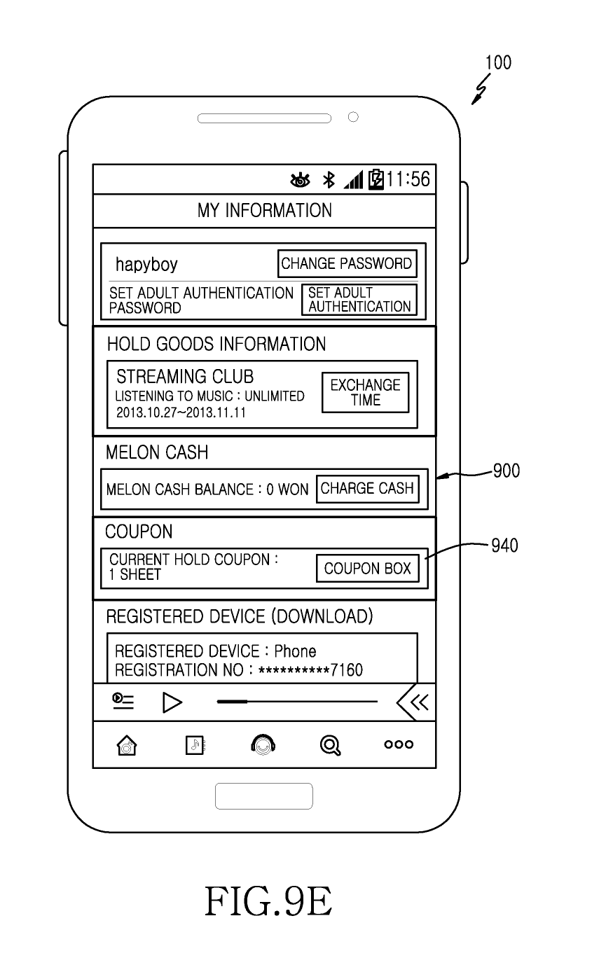

Referring to FIG. 8, a further example method is shown. Electronic device 100 may display a menu screen in operation 800. Referring to the example in FIG. 9A, electronic device 100 may display a plurality of user information or content information via the menu screen 900.

Electronic device 100 may identify whether a flat rate was paid for the content shown on information 910 on the menu screen 900. The information 910 of may include, but is not limited to, a access time 711, a remaining access time 713, and an entire access time 715 shown in FIG. 7A.

Electronic device 100 may determine whether a user has selected to have access to new content for a limited time for a flat rate in operation 810. If so, electronic device 100 displays a term exchange screen in operation 820.

By way of example, a user of electronic device 100 may select the information 910 shown in FIG. 9A. Referring to the example of FIG. 9B, electronic device 100 may display a term exchange screen 920. For example, the term exchange screen 920 may include items 921, 923, 925 such that each item displays information for particular content, including, but not limited to, a content use coupon, mileage information, or digital currency that may be exchanged for an unlimited access to content for a limited time.

Referring back to FIG. 8, electronic device 100 may identify whether content was previously purchased, in operation 830. Referring now again to the working example in FIG. 9B, a user of electronic device 100 is shown selecting new content which the user desires to exchange for the usage time of previously purchased content.

Referring back to FIG. 8, electronic device 100 may determine whether any access time of previously purchased content remains in operation 840. If so, electronic device 100 may obtain the new content for a new limited access time and subtract the new access time from the previous access time, in operation 850.

Referring now to FIG. 9C, Electronic device 100 may transmit the electronic payment to purchase the new content, and display a popup 930 representing the access time subtracted from the previous content. As shown in the example in FIG. 9D, electronic device 100 may also display information associated with the new content.

Referring now to FIG. 9E, A user of electronic device 100 may determine the remaining access time of the previously purchased content via the menu screen 900. Also, electronic device 100 may display coupon information 940 of the new content via the menu screen 900.

Advantageously, the techniques disclosed herein may permit a user to obtain access to content using prepaid access time for previously purchased content. In this regard, a newly generated access time for the new content may be subtracted from the prepaid content. In turn, users are provided with more flexibility, when purchasing content online.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method in an electronic device, the method comprising:
transmitting, using at least one processor, a request to a server for access to new content for a duration of time;
identifying, using at least one processor, whether access to previous content has been purchased;
identifying, using at least one processor, whether any prepaid access time remains for the previous content
subtracting, using at least one processor, the duration of time in which the new content is accessible from the prepaid access time, when access to the previous content was purchased and the prepaid access time remains; and
accessing, using at least one processor, the new content for at least some of the duration of time.

2. The method of claim 1, wherein subtracting the duration of time in which the new content is accessible from the prepaid access time results in a remaining access time for the previous content.

3. The method of claim 2, further comprising displaying, using at least one processor, the remaining access time that reflects a cost of the new content.

4. The method of claim 3, further comprising transmitting, using at least one processor, electronic payment to the server in exchange for access to the new content for the duration of time, when access to the previous content was not purchased.

5. The method of claim 1, further comprising transmitting, using at least one processor, electronic payment to the server in exchange for access to the new content for the duration of time, when no prepaid access time remains.

6. The method of claim 1, wherein the new content is accessed based on at least one of a purchase per use, a flat rate, and a measured rate arrangement.

7. The method of claim 1, wherein the duration of time in which the new content is accessible is based on a return on investment.

8. The method of claim 1, further comprising subtracting, using at least one processor, the duration of time in which the new content is accessible from the prepaid access time, when the prepaid access time is greater than the duration of time.

9. An electronic device comprising:
at least one processor to:
transmit electronic payment to a server over a network in exchange for access to electronic content for a predefined access time;
transmit a request to the server over the network for access to new electronic content different than the electronic content;
identify whether any of the predefined access time remains;
subtract a new access time associated with the new electronic content from the predefined access time that remains, when any of the predefined access time remains; and
access the new electronic content over the network for at least some of the new access time.

10. The electronic device of claim 9, wherein the new access time is a duration of time in which the new content is accessible.

11. The electronic device of claim 10, wherein the at least one processor to further display the predefined access time that remains and the new access time.

12. The electronic device of claim 11, wherein the at least one processor to transmit additional electronic payment to the server in exchange for access to the new content, when none of the predefined access time remains.

13. The electronic device of claim 9, wherein the electronic content comprises at least one of a photo, a video, a sound, an e-book, and text.

14. The electronic device of claim 9, wherein the at least one processor to access the new content based on at least one of a purchase per use, a flat rate, and a measured rate arrangement.

15. The electronic device of claim 9, wherein the new access time is based on a return on investment.

16. The electronic device of claim 9, wherein the at least one processor to subtract the new access time associated with the new electronic content from the predefined access time that remains, when the predefined access time that remains is greater than the new access time.

17. A method for operating an electronic device, the method comprising:
transmitting, using at least one processor, electronic payment to a server over a network in exchange for access to electronic content for a predefined access time;
transmitting, using at least one processor, a request to the server over the network for access to new electronic content different than the electronic content;
identifying, using at least one processor, whether any of the predefined access time remains;
identifying, using at least one processor, a new access time in which the new electronic content is accessible;
subtracting, using at least one processor, the new access time from the predefined access time that remains, when the predefined access time remains and the predefined access time that remains is greater than the new access time; and
accessing, using at least one processor, the new electronic content over the network for at least some of the new access time.

18. A method comprising:
detecting, using at least one processor, receipt of a request for access to new content from a remote device;
identifying, using at least one processor, whether electronic payment was received from the remote device for access to previous content;
identifying, using at least one processor, whether any prepaid access time remains for the previous content;
calculating, using at least one processor, a limited access time in which the new content is accessible, the limited access time being based on a return on investment;
subtracting, using at least one processor, the limited access time from the prepaid access time, when access to the previous content was purchased, the prepaid access time remains, and the prepaid access time that remains is greater than the limited access time; and
permitting, using at least one processor, the remote device to access the new content for the limited access time.
